(19) United States
(12) Patent Application Publication
(10) Pub. No.: US 2022/0230817 A1
(43) Pub. Date: Jul. 21, 2022

(54) SWITCH ASSEMBLY WITH DRIVE SYSTEM, AND METHOD FOR DRIVING A SWITCH ASSEMBLY

(71) Applicant: Maschinenfabrik Reinhausen GmbH, Regensburg (DE)

(72) Inventors: Klaus Ixmeier, Thumhausen (DE); Eugen Nagel, Regensburg (DE); Eduard Zerr, Regensburg (DE)

(21) Appl. No.: 17/611,208

(22) PCT Filed: Apr. 23, 2020
(86) PCT No.: PCT/EP2020/061295

§ 371 Date: Nov. 15, 2021

(30) Foreign Application Priority Data
May 15, 2019 (DE) 10 2019 112 714.9

(51) Int. Cl. H01H 3/26; H01H 9/00

(52) U.S. Cl. CPC H01H 3/26; H01H 2003/266; H01H 9/0027

(57) ABSTRACT

A switch assembly includes a switch, and a servo drive system for the switch. The servo drive system includes a motor configured to drive the switch; a power section configured to supply power to the motor; and a controller embodied as a programmable safety controller configured to actuate the power section depending on a desired value.

### CROSS REFERENCE TO RELATED APPLICATIONS

This application is a U.S. National Phase application under 35 U.S.C. § 371 of International Application No. PCT/EP2020/061295, filed on Apr. 23, 2020, and claims benefit to German Patent Application No. DE 10 2019 112 714.9, filed on May 15, 2019. The International Application was published in German on Nov. 19, 2020 as WO 2020/229131 A1 under PCT Article 21(2).

### FIELD

The invention relates to a switch assembly having a switch and a drive system for the switch, and also to a method for driving a switch.

### BACKGROUND

In substations, there are a large number of switches for different tasks and with different requirements. To operate the various switches, they must be driven via a drive system. These switches include, amongst others, on-load tap-changers, diverter switches, selectors, double reversing change-over selectors, reversing change-over selectors, change-over selectors, circuit breakers, on-load switches or disconnecting switches.

For example, on-load tap-changers are used for uninterrupted switchover between different winding taps of an item of electrical equipment, such as a power transformer or a controllable reactor. For example, this makes it possible for the transmission ratio of the transformer or the inductance of the reactor to be changed. Double reversing change-over selectors are used to reverse the polarity of windings during power transformer operation.

All of these switches represent a highly safety-relevant component of the electrical equipment, because the switchover takes place while the equipment is in operation and is accordingly connected to a power network, for example. In extreme cases, malfunctions during operation can have serious technical and economic consequences.

### SUMMARY

In an embodiment, the present disclosure provides a switch assembly including a switch, and a servo drive system for the switch. The servo drive system includes a motor configured to drive the switch; a power section configured to supply power to the motor; and a controller embodied as a programmable safety controller configured to actuate the power section depending on a desired value.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a schematic representation of an exemplary embodiment of a switch assembly according to the improved concept; and

FIG. 2 a schematic representation of a further exemplary embodiment of a switch assembly according to the improved concept.

### DETAILED DESCRIPTION

Embodiments of the present invention provide an improved concept for driving a switch, in particular an on-load tap-changer, diverter switch, selector, double reversing change-over selector, reversing change-over selector, change-over selector, circuit breaker, on-load switch or disconnecting switch, by means of which concept the operational reliability is increased.

Exemplary embodiments of the present invention are based on, among other things, the idea of designing the drive system as a servo drive system and equipping it with a programmable safety controller by means of which a power section of the drive system is controlled in an open-loop or closed-loop fashion.

According to exemplary embodiments of the present invention, a switch assembly is disclosed which includes a switch and a servo drive system for the switch. The servo drive system has a motor for driving the switch, a power section for supplying power to the motor and a control unit embodied as a programmable safety controller for actuating the power section depending on at least one desired value.

The switch can be configured as an on-load tap-changer or a diverter switch or selector or a double reversing change-over selector or a reversing change-over selector or a change-over selector or a circuit breaker or an on-load switch or a disconnecting switch.

A servo drive system denotes a drive system which electronically controls the motor, wherein the control can include a position control, angle control or location control, a speed control or revolution control, an acceleration control and/or a torque control. The term servo drive system therefore implies that the drive system has a device for detecting one or more of the control variables mentioned and for returning a corresponding feedback signal to the control unit and that the control is performed using the feedback signal.

The actuation of the power section depending on the at least one desired value corresponds to a control in this sense.

The programmable safety controller refers to a controller that contains two processor units, in particular two programmable logic controllers (PLCs). The two processor units use the same process image of inputs and outputs of the control unit and run in parallel a user program stored in the control unit.

According to at least one embodiment, the user program contains multiple instructions. When the instructions are executed by the control unit, this results in the power section being actuated in response to the desired value. This drives the motor, and ultimately the switch, to perform one or more operations, such as a switchover between two winding taps of an item of equipment, or parts of the switchover, such as a diverter switch operation, selector operation, or change-over selector operation. According to at least one embodiment, in order to drive the switch, in particular on-load tap-changer, diverter switch, selector, double reversing change-over selector, reversing change-over selector, change-over selector, circuit breaker, on-load switch, the motor is coupled, via one or more gear units, to a shaft or some other component of the switch, in particular on-load tap-changer, diverter switch, selector, double reversing change-over selector, reversing change-over selector, change-over selector, circuit breaker, on-load switch.

According to at least one embodiment, the power section is designed as a converter, in particular a servo converter, or as an equivalent electronic unit, in particular fully electronic unit, for drive machines.

According to at least one embodiment, the control unit includes a first and a second processor unit. The control unit is designed to run a program, in particular the user program, in order to implement a switching command for the switch, wherein the first and second processor units run the program in parallel.

The use of the programmable safety controller as a control unit and the associated redundancy increase the operational reliability of the switch assembly.

According to at least one embodiment, the control unit is designed to perform at least one reconciliation between the first and the second processor unit during the running of the program, in particular a continuous reconciliation.

According to at least one embodiment, the reconciliation includes a comparison, in particular a cyclic comparison, of a process image of the first processor unit with a process image of the second processor unit.

According to at least one embodiment, the control unit is designed to initiate a safety measure depending on a result, in particular in the event of a negative result, of the at least one reconciliation or the comparison of the process images.

According to at least one embodiment, the safety measure includes a safe stopping of the motor, a blocking or shutdown of the power section or a tripping of a circuit breaker that connects or disconnects the equipment to a power network. The motor is stopped safely in particular in such a way that the on-load tap-changer is in a safe position after the safe stopping. The initiation of the safety measure includes the output of at least one safety signal.

According to at least one embodiment, the safe stopping of the motor includes a safety function that corresponds to a stop category as defined in accordance with industry standard EN 60204-1:2006, the content of which is hereby incorporated by reference herein.

According to at least one embodiment, the safe stopping of the motor includes a safe-torque-off (STO) safety function, a safe-stop-1 (SS1) safety function, a safe-stop-2 (SS2) safety function, or a safe-operation-stop (SOS) safety function.

According to at least one embodiment, a hardware of the first processor unit is different from a hardware of the second processor unit. This creates diverse redundancy, which further increases operational reliability.

According to at least one embodiment, the control unit is designed to check a locking condition of two or more components of the switch assembly.

The components of the switch assembly can include components of the switch, in the case of an on-load tap-changer for example a selector, a change-over selector, a tie-in circuit, or a diverter switch of the on-load tap-changer.

The components of the switch assembly may also include components that are not part of the switch, in particular components of another switch of the switch assembly or of another switching component of the switch assembly. For example, two switches that are configured as on-load tap-changers may be on-load tap-changers for different phases of the power network. The other switching components may include, for example, a double reversing change-over selector, reversing change-over selector, circuit breaker, on-load switch.

The locking condition can correspond to a specification that one of the components may only be actuated or may not be actuated if another of the components is in a certain state, for example a certain position, a certain switching state or a certain movement state.

According to at least one embodiment, the control unit is designed to initiate the safety measure depending on a result, in particular in the event of a negative result of the checking of the locking condition.

By checking the locking condition and, if necessary, initiating the safety measure, the operational reliability can be further increased without requiring specific design measures for the switch, in particular on-load tap-changer or the other components, such as mechanical or electromechanical systems, cam switches or the like.

According to at least one embodiment, the switch assembly is associated with an item of electrical equipment, for example a power transformer or a phase shifter transformer.

According to at least one embodiment, the control unit has inputs and outputs which are designed as clocked inputs and outputs, respectively.

According to at least one embodiment, the control unit is designed to check for the presence of a cross-circuit on the basis of input signals present at the inputs and/or on the basis of output signals present at the outputs.

A cross-circuit is a short-circuit between the connecting leads of two adjacent inputs or outputs.

According to at least one embodiment, the control unit is designed to initiate the safety measure depending on a result of the check, in particular if a cross-circuit is present.

According to the improved concept, a method for driving a switch assembly is also disclosed. The method comprises actuating a power section of the switch assembly using a programmable safety controller depending on a desired value and implementing a switching command for a switch of the switch assembly. The implementation of the switching command is carried out by running a program in parallel using two processor units.

Further embodiments and implementations of the method are directly apparent from the various embodiments of the switch assembly. In particular, individual or multiple components and/or arrangements which are described in relation to the switch assembly can be correspondingly implemented for carrying out the method.

In the following, the invention is explained in detail on the basis of exemplary embodiments with reference to the drawings. Components which are identical or functionally identical or which have an identical effect may be provided with identical reference signs. Identical components or components having an identical function may in some cases be explained only in relation to the figure in which they first appear. The explanation is not necessarily repeated in the subsequent figures.

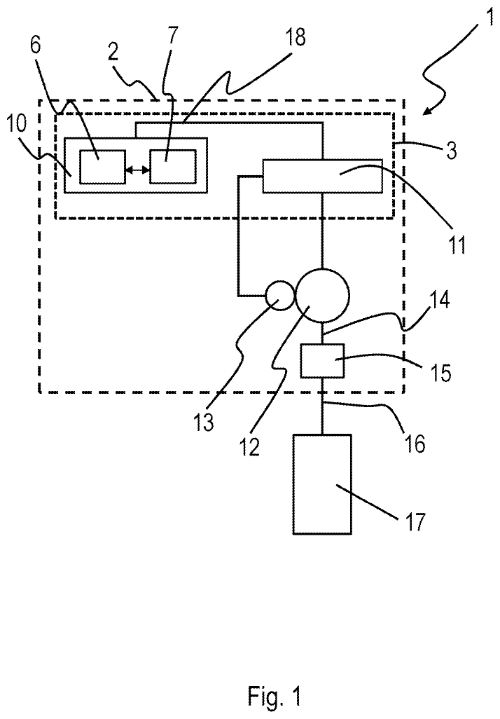

FIG. 1 shows a schematic representation of an exemplary embodiment of a switch assembly according to the improved concept with a switch 17 and a servo drive system, which is connected to the switch 17 via a drive shaft 16. The servo drive system 2 includes a motor 12, which can drive the drive shaft 16 via a motor shaft 14 and optionally via a gear unit 15. A control device 3 of the servo drive system 2 comprises a power section 11, which contains for example a servo converter, for the open-loop- or closed-loop-controlled power supply of the motor 12, and a control unit 10 for actuating the power section 11, for example via a bus 18.

The servo drive system 2 may have an encoder system 13, which serves as a feedback system or is part of the feedback system and is connected to the power section 11. Furthermore, the encoder system 13 is directly or indirectly coupled to the drive shaft 16.

The encoder system 13 is designed to detect a value for a position, in particular an angular position, for example an absolute angular position, of the drive shaft 16 and to generate a feedback signal based thereon. For this purpose, the encoder system 13 can comprise, for example, an absolute encoder, in particular a multi-turn absolute encoder, which is attached to the drive shaft 16, the motor shaft 14 or another shaft of which the position is unambiguously linked to the absolute position of the drive shaft 17. For example, the position of the drive shaft 17 can be unambiguously determined from the position of the motor shaft 14, for example via a transmission ratio of the gear unit 14. The control device 3, in particular the control unit 10 and/or the power section 11, is designed to control the motor 12 in an open-loop or closed-loop fashion depending on the feedback signal.

The fastening of the absolute encoder is embodied, for example, as a combination of an interlocked connection with a frictionally engaged or integrally bonded connection.

The control unit 10 is designed as a programmable safety controller and includes, for example, a first and a second programmable logic controller 6, 7. To implement a switching command for the on-load tap-changer, the programmable logic controllers 6, 7 run a program in parallel, for example.

Whilst the program is being run, the programmable logic controllers 6, 7 can reconcile themselves with each other, in particular cyclically or continuously. The reconciliation can include, for example, a comparison of calculation results, checksums or the like.

For example, the programmable logic controllers 6, 7 contain different hardware components or are embodied as different types or models.

Inputs and outputs of the control unit 10 can be embodied as clocked inputs and outputs. This allows the control unit to detect clock deviations, for example deviations in period durations or edges of the signals, based on a comparison of an input signal with an output signal. Based on the clock deviations, cross-circuits can be detected, for example.

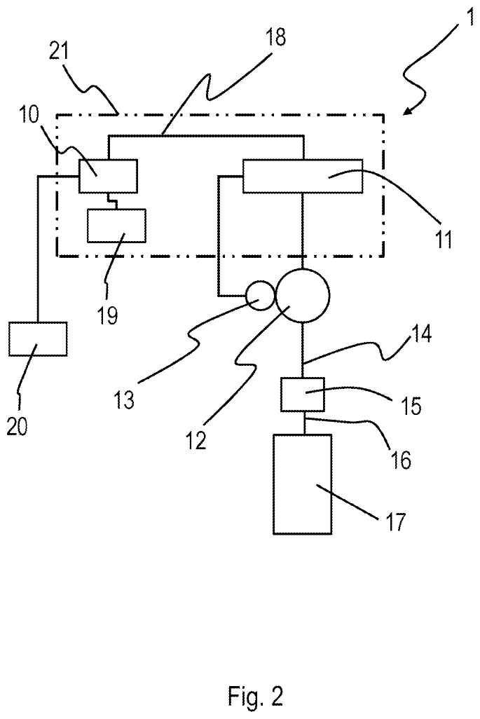

FIG. 2 shows a schematic representation of a further exemplary embodiment of a switch assembly according to the improved concept, which is based on the embodiment according to FIG. 1.

The switch device here optionally has a control cabinet 21, within which the control unit 10, the power section 11 and an optional man-machine interface 19 are arranged. The man-machine interface 19 is connected to the control unit 10 and can serve for control, maintenance or configuration purposes, for example.

The motor 12, the motor shaft 14 the encoder system 13 and/or the gear unit 15 can be located inside or outside the control cabinet.

The switch assembly, in particular the control unit 10, is coupled to a safety device 20, which comprises, for example, a circuit breaker, in order to disconnect the switch assembly or an item of electrical equipment to which the switch assembly is assigned from a power network, for example in the event of a fault or malfunction of the tap changer assembly 1.

A tap changer assembly according to the improved concept increases the operational safety of the servo drive system, the on-load tap-changer and the equipment. This is achieved in particular by the use of the programmable safety controller as a control unit and the associated redundancy.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 Switch assembly
2 Servo drive system
3 Control device
6 First processor unit/programmable logic controllers
7 Second processor unit/programmable logic controllers
10 Control unit
11 Power section
12 Motor
13 Encoder system
14 Motor shaft
15 Gear unit
16 Drive shaft
17 On-load tap-changer
18 Bus
19 Man-machine interface
20 Safety device
21 Control cabinet

1: A switch assembly, the switch assembly comprising:
a switch; and
a servo drive system for the switch, the servo drive system comprising:
a motor configured to drive the switch;
a power section configured to supply power to the motor; and
a programmable safety controller configured to actuate the power section depending on a desired value.

2: The switch assembly as claimed in claim 1, wherein the controller comprises a first processor and a second processor,
wherein the controller is configured to run a program to implement a switching command for the switch, and
wherein the first processor and second processor are configured to run the program in parallel.

3: The switch assembly as claimed in claim 2, wherein the controller is configured to carry out at least one reconciliation between the first processor and the second processor whilst the program is being run.

4: The switch assembly as claimed in claim 3, wherein the controller is configured to initiate a safety measure depending on a result of the at least one reconciliation.

5: The switch assembly as claimed in claim 4, wherein the safety measure comprises tripping a circuit breaker to disconnect an item of equipment associated with the switch from a power network.

6: The switch assembly as claimed in claim 4, wherein the safety measure comprises a safe stopping of the motor.

7: The switch assembly as claimed in claim 4, wherein the safety measure comprises a shutdown or blocking of the power section.

8: The switch assembly as claimed in claim 2, wherein the controller is configured to carry out a comparison of a process image of the first processor with a process image of the second processor whilst the program is being run.

9: The switch assembly as claimed in claim 2, wherein a hardware of the first processor is different from a hardware of the second processor.

10: The switch assembly as claimed in claim 1, wherein the controller is configured to check a locking condition of two or more components of the switch assembly.

11: The switch assembly as claimed in claim 1, wherein the controller comprises inputs and outputs which are configured as clocked inputs and outputs, respectively.

12: The switch assembly as claimed in claim 11, wherein the controller is configured to check for the presence of a cross-circuit based on input signals or output signals which are present at the inputs or outputs, respectively.

13: The switch assembly as claimed in claim 1, wherein the switch is an on-load tap-changer or a diverter switch or selector or a double reversing change-over selector or a reversing change-over selector or a change-over selector or a circuit breaker or an on-load switch or a disconnecting switch.

14: A method for driving a switch assembly, the method comprising:
actuating a power section of the switch assembly using a programmable safety controller depending on a desired value;
implementing a switching command for a switch of the switch assembly; and
running a program in parallel using two processors in order to implement the switching command.
